(19) United States
(12) Patent Application Publication
(10) Pub. No.: US 2023/0239206 A1
(43) Pub. Date: Jul. 27, 2023

(54) Topology Alarm Correlation

(71) Applicant: Rakuten Mobile, Inc., Tokyo (JP)

(72) Inventors: Nimit AGRAWAL, Madhya Pradesh (IN); Akash SONI, Madhya Pradesh (IN)

(21) Appl. No.: 17/581,982

(22) Filed: Jan. 24, 2022

(51) Int. Cl. H04L 41/0816; H04L 41/0859; H04L 41/08; H04L 41/0604; H04L 41/12

(52) U.S. Cl. CPC H04L 41/0816; H04L 41/0859; H04L 41/0883; H04L 41/0627; H04L 41/12

(57) ABSTRACT

A faulty node is identified in a cloud native environment by retrieving a topology that describes a relationship between a plurality of nodes in a network, retrieving a list of alarms in the network, determining a child node in the network located at the bottom of the topology that has a first alarm based on the alarm list, determining a parent node of the child node located above the child node and below or on an apex node of the network that has a second alarm based on the topology, determining whether the parent node is an apex node in the network based on the topology, and based on a determination that the parent node is the apex node in the network, identify the parent node as the faulty node.

### BACKGROUND

Open Radio Access Network (RAN) is a standard for RAN interfaces that allow interoperability of equipment between vendors. Open RAN networks allow flexibility in where the data received from the radio network is processed. Open Ran networks allow processing of information to be distributed away from the base stations. Open RAN networks allow managing the network at a central location.

The flexible RAN includes multiple elements such as routers and other hardware distributed over a wide area. The flexible RAN routers have dependencies on other network hardware.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a system for topology alarm correlation, according to at least one embodiment of the present system.

FIG. 2 is a diagram of a system for executing an exemplary pseudocodes for determining which node in the upper layer is faulty node, according to at least one embodiment of the present system.

FIG. 3 is a diagram of a system for an exemplary pseudocode to check the number of children that are below a faulty node, according to at least one embodiment of the present system.

FIG. 4 is an operational flow of a method for determining a faulty node in the network, according to at least one embodiment of the present system.

FIG. 5 is a block diagram of an exemplary hardware configuration for automatic cell range detection, according to at least one embodiment of the present system.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

In some embodiments, a system identifies a faulty node in a network based on topology of the network and a list of alarms in a cloud environment for managing a radio network. For example, the system is able to determine a suspected a faulty node in a network based a correlation between the network topology and the list of alarms to identify a node where an error associated with an alarm in the network originates. In some embodiments, the system is able to use the network topology information to quickly troubleshoot the faulty node when there are multiple alarms in the network. In some embodiments, the alarm can originate at a parent node which is faulty and cascade into a child node because the network traffic is affected in the child node because of the error in the parent node. For example, the system uses the network topology that represents the hierarchy and relationships between a plurality of nodes in the network to identify the faulty node based on a correlation between the topology and the list of alarms.

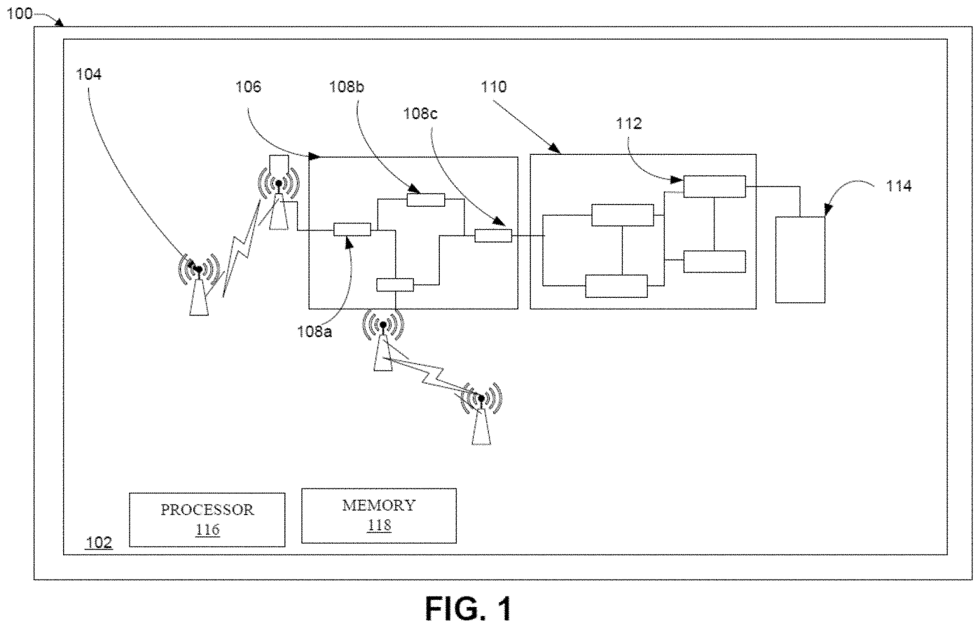

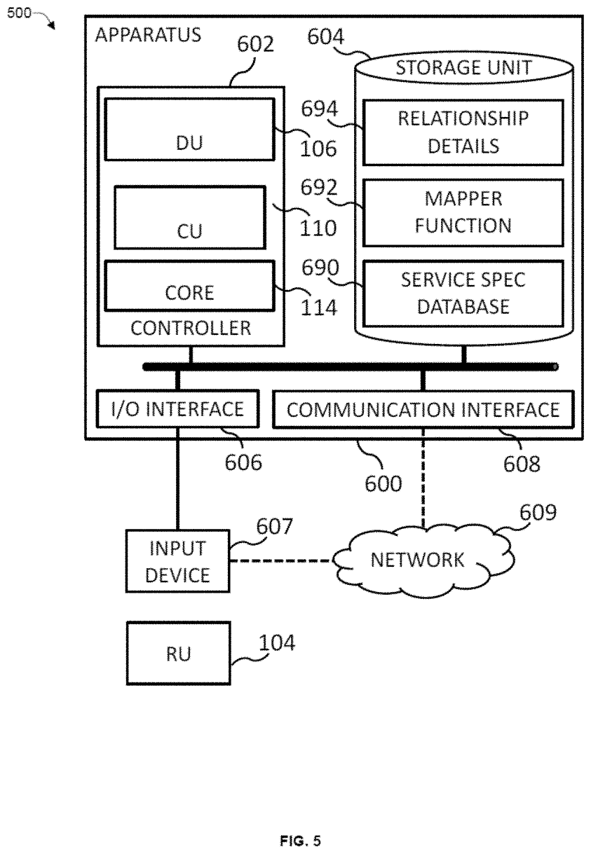

In some embodiments, the system determines the faulty node based on a correlation between the hierarchy of the nodes in the network and the node that is highest in the hierarchy with an alarm from the list of alarms. In some embodiments, the system determines the faulty node without troubleshooting each of the nodes connected to the faulty node through correlation. The use of correlations to determine the faulty node helps to improve the efficiency of identification of the faulty node in contrast to a trial-and-error approach. In some embodiments, the system saves computing resources and identifies the faulty node quickly based on correlation. In some embodiments, the system resolves alarms in the list of alarms by solving the issue at the faulty node that causes the problem without individually troubleshooting the nodes that also have alarms because the alarms are connected to the faulty node. FIG. 1 is a diagram of a system 100 for topology alarm correlation, according to at least one embodiment of the present system. The diagram includes system 100 for hosting a cloud architecture 102. In some embodiments, the system 100 includes components described hereinafter in FIG. 5. In some embodiments, the system 100 hosts a cluster of servers, such as a cloud service. In some embodiments, the system 100 hosts a public cloud. In some embodiments, the system 100 hosts a private cloud.

The system 100 includes a Radio Unit (RU) 104, a Distributed Unit (DU) 106, a centralized Unit (CU) 110 and a core 114. In some examples, the operations of the components of the system 100 are executed by a processor 116 based on machine readable instructions stored in a non-volatile computer readable memory 118. In some examples, one or more of the operations of the components of the system 100 are executed on a different processor. In some examples, the operations of the components of the system 100 are split between multiple processors.

In some embodiments, the cloud architecture 102 is an Open RAN environment, the RAN is disaggregated into three main building blocks, the Radio Unit (RU) 104, the Distributed Unit (DU) 106, and the centralized Unit (CU) 110. In some embodiments, the RU 104 receives, transmits, amplifies, and digitizes the radio frequency signals. In some embodiments, the RU 104 is located near, or integrated into the antenna to avoid or reduce radio frequency interference. In some embodiments, the DU 106 and the CU 114 form a computational component of a base station, sending the digitalized radio signal into the network. In some embodiments, the DU 106 is physically located at or near the RU 104. In some embodiments, the CU 110 is located nearer the core 114. In some embodiments, the cloud environment 102 implements the Open RAN based on protocols and interfaces between these various building blocks (radios, hardware and software) in the RAN. Examples of Open RAN interfaces include a front-haul between the Radio Unit and the Distributed Unit, mid-haul between the Distributed Unit and the Centralized Unit and Backhaul connecting the RAN to the core 114. In some embodiments, the DU 106 and the CU 110 are virtualized and run in a server or a cluster of servers.

The system 100 is configured to detect a faulty node (e.g., a parent 108b ) in the network. In some embodiments, the system 100 retrieves a topology from a database. In some embodiments, the topology of the network describes a relationship between nodes in a network. For example, the RU 104, the DU 106 and the CU 110 are linked together in different ways using different nodes. In some embodiments, a virtual machine or a cluster of virtual machines performs the function of the DU 106. In some embodiments, the system 100 dynamically reconfigures the nodes of the DU 106, and CU 110 based on the network requirements. For example, during a sports event the system 100 reconfigures the DU 106 serving a sports stadium with a cluster of servers or a cluster of virtual machines to handle the extra processing brought on by sports fans. In at least one example, the system 100 configures the DU 106 to house an apex node 108a connected to a parent node 108b and a child node 108c. In some embodiments, the apex node 108a is a node that has no parent nodes located at a hierarchical level above the node. In some embodiments, the apex node 108a connects to other nodes that are on the same hierarchical level. In some embodiments, the apex node 108a connects to nodes that are at a hierarchical level below the apex node 108a such as a parent node 108b and a child node 108c.

In some embodiments, the system 100 configures the apex node 108a to interact with multiple other nodes. The system 100 stores the relationship between the nodes and between different parts of the Open RAN such as DU 106, CU 110 in the network topology. In some embodiments, the system 100 retrieves a list of alarms in the network from a database. In some embodiments, the list of alarms is based on logs of alarms generated by nodes in the network. In some embodiments, the list of alarms in the network are generated when a node has an issue. For example, when the apex node 108a fails the system 100 retrieves a list of alarms that include the alarm generated at the apex node 108a and other nodes that are related to the apex node 108a based on the topology. In one or more examples, the list of alarms includes alarms at the child node 108c and the parent node 108b because of cascade of failures in network traffic as a result of the failure in the apex node 108a. In some embodiments, the list of alarms in the network are tied to nodes in the network.

In some embodiments, a failure in the DU 106 causes a corresponding alarm in the CU 110. In one or more examples, a failure in the apex node 108a cascades to a node 112 in the CU 110.

In some embodiments, the system 100 retrieves a list of alarms in the network that are active in the network. In one or more examples, an alarm is active when the failure of one or more nodes in the network has not been fixed and the flow of information between the nodes in the system is disrupted. In some embodiments, the system 100 retrieves a list of alarms in the network that are closed alarms that were closed within a threshold closing time. In one or more examples, an alarm is closed when the failure of one or more nodes is fixed and as a result the network starts functioning and the flow of information between the nodes in the system is restored. In some embodiments, the threshold closing time is twenty-four hours. In some examples, the threshold closing time is chosen based on a value that reduces the processing power of the cloud architecture 102 such that the threshold closing time does not result in degradation of the ability to identify the faulty node. In some embodiments, the system 100 determines a child node 108c in the network located at or near the bottom of the topology that has a first alarm based on the alarm list. In some embodiments, the system 100 determines the child node 108c is at the bottom level of the hierarchy of the network in response to the alarms in a parent node that are faulty affecting the child node 108c. In some embodiments, errors and corresponding alarms in the parent node can in errors and alerts in the child node 108c.

In some embodiments, the system 100 determines the child node 108c is not at the bottom of the network, in response to the alarms not being generated at the lower hierarchy as a result of alarms at a node above the bottom layer of the hierarchy. In some embodiments, the system 100 determines the topology based on a user configured topology rule. In some examples, the user configured topology correlation rule describes a configuration of one or more components of the network such as the DU 106, CU 108 and the like and the interconnection between the nodes in these components. In some embodiments, the system 100 determines the parent node 108b of the child node 108c located above the child node 108b and below or on the same hierarchical level an apex node 108a of the network that has a second alarm based on the topology. In some embodiments, the second alarm is triggered on the apex node 108a due to a fault in the apex node 108a hardware or configuration. In some embodiments, the second alarm on the apex node 108a cascades resulting in alarms in the parent node 108b, the child node 108c or a combination thereof based on the topology of the network.

In some embodiments, the system 100 determines whether the parent node 108b is the apex node 108a in the network based on the topology. In some embodiments, the system 100, in response to a determination that the parent node 108a is on the same hierarchical level as the apex node 108a in the network, identifies the parent node 108a as the faulty node. In some embodiments, the system 100 determines the faulty node based on a node type ranking template when there is more than one alarm at the same hierarchy of the network. In some embodiments, the system 100 determines the faulty node based on the node where the alarm was first triggered between nodes in the same hierarchy level without running a diagnostic on each of the nodes in the hierarchy to determine whether there is a hardware failure, a failure in the software, or an error in configuration of the node.

In some embodiments, the system 100 clears the faulty node alarm after fixing the error associated with an alarm in the faulty node. In some embodiments, the system 100 determines whether the other alarms in the network persist after the error in the faulty node is fixed. In some embodiments, the system 100 fixes an error in the faulty node by reconfiguring the node. In some embodiments, the system 100 reconfigures the node by resetting the node to a factory default state and then changing a parameter in the device. In some embodiments, the system 100 alerts an administrator to fix an error in a node. In some embodiments, the alert includes a wirelessly transmitted alert to a mobile device controllable by the administrator. In some embodiments, the alert includes causes an audio or visual alert on the mobile device. In some embodiments, the system 100 receives a message when the node is fixed from the administrator.

In some embodiments, the system 100 determines an incident end time based on the time elapsed between the time the faulty node alarm was triggered and an end time when the faulty node was fixed. In some embodiments, the incident end time is based on the time the faulty alarms are closed after the faulty node is reconfigured or replaced. In one or more examples a faulty node alarm in the node 108a cascades to the node 108b and 108c. In an embodiment, the system 100 determines the start time of the faulty node alarm is the time of the earliest faulty alarm in the hierarchy. For example, the system 100 determines the start time based on the time of the faulty node alarm on node 108a. In an embodiment, the system 100 determines the end time based on the time the last faulty alarm in the hierarchy is resolved. For example, the system 100 determines the end time based on the time the alarm in the node 108c is resolved. In some embodiments, the system 100 determines the incident time based on the time elapsed between the earliest start time of an alarm on a node that is higher in the hierarchy and the last end time of the alarm in a node that is lower in the hierarchy. In some embodiments, the system 100 determines the end time based on the time the faulty alarm in the highest node with a fault is resolved.

In some embodiments, the system 100 determines whether the list of alarms and associated errors in the network or network outage are resolved based on the incident end time. In some embodiments, the system 100 uses the incident end time to determine whether the alarms are closed alarms or active alarms for diagnosing a future incident. In some embodiments, the system 100 uses the incident end time to calculate network availability metrics. In some embodiments, the system 100 monitors and identifies the faulty node based on the topology and the topology correlation rules to quickly identify the faulty node in the network based on the list of alarms and the topology of the network.

In some embodiments, the system 100 identifies the child node 108c with an alarm and tags the child node 108c to a parent node 108b because the error associated with the alarm in the parent node 108b cascades to the child node 108c triggering an alarm in the child node 108c. In some embodiments, the system 100 identifies the nodes with faults by traversing the topology and checking alarms in each node based on the topology of the network which increases the efficiency of the process by targeting nodes that are more likely to be at fault. In some embodiments, the system 100 traverses the hierarchy until a node is found in which there is no alarm. The system 100 associates an alarm in the list of alarms to a faulty node based on the correlation between the alarms and the topology. In some embodiments, the system 100, after traversing the topology correlation for a particular incident, identifies a second highest node faulty in the network. In some embodiments, the system 100 identifies and associates nodes with alarms to a second fault and so on until the active alarms are processed.

The system 100 resolves the fault and converts the set of alarms that were resolved into to an incident. In some embodiments, an incident corresponds to a resolved alarm or list of alarms that are related. In at least one example, an incident is a network outage due to errors associated with alarms in one or more nodes in the network that was resolved. In some embodiments, the system 100 resolves the fault by replacing a node, replacing a configuration file on a node, software on a node or the like to convert the set of alarms into the incident. In some embodiments, the system 100 is stores the set of alarms that were resolved in a database in an incident report.

In an example, the system 100 determines based on the topology of four nodes in a network that are connected such that A is connected to B, B is connected C and C is connected to D, where the nodes A and B are child nodes of C and D is a parent node of C. For example, the system 100 determines that A, B and C nodes are not part of an alarm if alarm has not occurred on node C based on the topology because an error associated with an alarm in C will result in a cascade of errors associated with alarms in the other nodes.

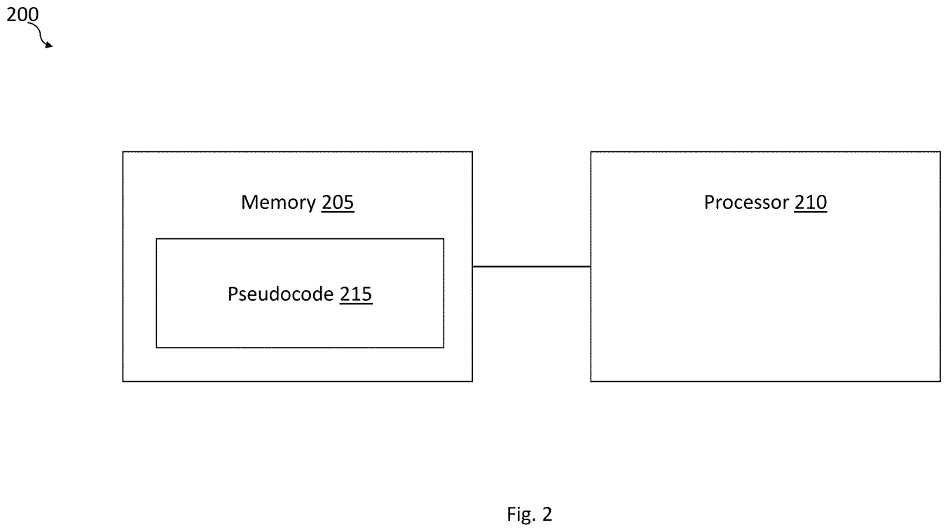

FIG. 2 is a diagram of a system 200 for executing a pseudocode for determining which node in an upper layer is faulty, according to at least one embodiment of the present system. The system 200 includes a memory 205 configured to store a pseudocode 215. The memory 205 is connected to a processor 210 for executing the pseudocode 215. In some embodiments, a pseudocode 215 determines which node in a network topography is defective. In some embodiments, the pseudocode 215 starts at or near the bottom of the hierarchy of a network based on the topology of the network. In some embodiments, the pseudocode 215 then checks if the parent node is not working or is faulty. In some embodiments, the pseudocode 215 determines whether the parent node is not working based on an outage at the parent node. In some embodiments, the pseudocode 100 checks for alarms in the parent node. In some embodiments, the pseudocode 215 then checks if the grandparent node of the parent node has an alarm. In some embodiments, if the grandparent node of the parent node has no alarm, the pseudocode 215 determines that the parent node is the faulty node. In some embodiments, the faulty node is responsible for other alarms in child nodes or sibling nodes that are otherwise not faulty. In some embodiments, if the grandparent node of the parent node has an alarm, the pseudocode 215 moves one level until a node is found with an alarm and where the immediate parent of the node has no alarm.

In some embodiments, the pseudocode 215 continues until an apex node is reached if all nodes within the topology have alarms. In some embodiments, the system 100 (FIG. 1) determines the parent node 108b that is creating the outage by traversing the network one hierarchy level at a time based on the topography. In some embodiments, the system 100 determines the parent farthest away from the child node 108c to identify the faulty node, by traversing the nodes one hierarchy level at a time until there are no more alarms. In some embodiments, the system 100 uses the pseudocode 215 for determining which node above a child node 108c is a faulty node which leads to cascading alarms in the child nodes.

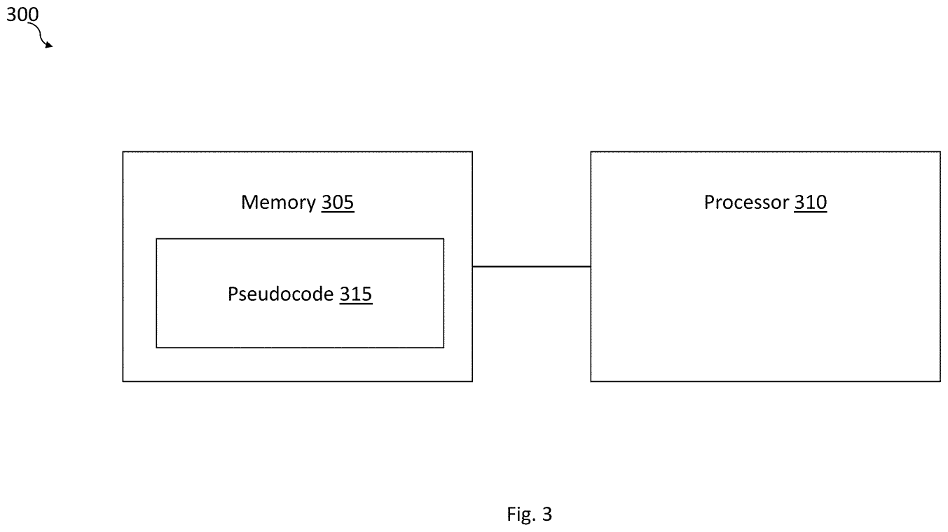

FIG. 3 is a diagram of a system 300 for executing a pseudocode to check the number of children that are affected by the faulty node, according to at least one embodiment of the present system. The system 300 includes a memory 305 configured to store a pseudocode 315. The memory 305 is connected to a processor 310 for executing the pseudocode 315. In some embodiments, the pseudocode 315 determines the number of child nodes affected by an outage. In some embodiments, the pseudocode 315 determines the level of the parent node outage where the immediate grandparent node is without an alarm. In some embodiments, the pseudocode 315 determines the parent node with the fault based on pseudocode 215 (FIG. 2). In some embodiments, the pseudocode 300 checks if there is an outage in an immediate child node of a parent node with an outage and increments a count of outages based on the result of the check. In some embodiments, the pseudocode 300 checks if there is a child node with an outage if a parent node has an outage or fault.

In some embodiments, based on the child node having an outage, the pseudocode 315 checks other child nodes that are connected to the node with the fault or outage and increments the counter if there is an outage. In some embodiments, the pseudocode 315 determines the count of child nodes that are affected in response to no more child nodes being connected to the parent node with the fault. In some embodiments, the system 100 (FIG. 1) determine the number of child nodes that are affected by the faulty parent node 108b. The system 100 checks whether a parent has an alarm based on the list of alarms starting at the apex node 108a. In some embodiments, the system 100 traverses to the lower level from the first level with an alarm to determine the number of children impacted by the alarm. In some embodiments, the system 100 consolidates the alarms that are linked to a faulty parent node 108b to allow duplicate alarms to be removed. In some embodiments, the system 100 uses the pseudocode 315 for determining the number of child nodes such as 108c that are impacted due to the faulty parent node 108b.

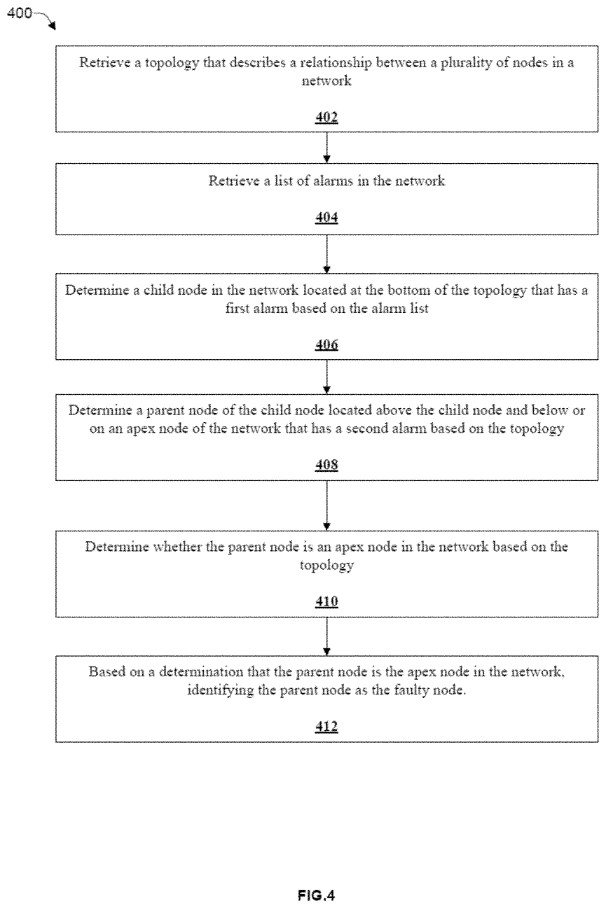

FIG. 4 is an operational flow for a method 400 of determining a faulty node in a network in accordance with at least one embodiment. In some embodiments, the method 400 is implemented using a controller of a system, such as system 100 (FIG. 1), or another suitable system. In at least some embodiments, the method is performed by the system 100 shown in FIG. 1 or a controller 500 shown in FIG. 5 including sections for performing certain operations, such as the controller 500 shown in FIG. 5 which will be explained hereinafter. At S402, the controller, receives a topology that describes a relationship between nodes in the network. In some embodiments, the controller receives a user configured topology correlation rule that provides information about the relationship between nodes in the network based on the type of network. For example, in some embodiments, the user configured topology correlation rule describes the relationship between a router and a firewall in a layer of the open RAN network. In some embodiments, the controller determines the topology based on the user configured topology configuration rule. In at least one example, the controller, such as the controller in FIG. 5 receives a topology that describes a relationship between nodes in the network.

In some embodiments, at S404, the controller retrieves a list of alarms in the network from a database. In some embodiments, the list of alarms is based on logs generated when there are access errors or network errors in a node of the network. In some embodiments, the nodes generate messages when there are errors in network access or when there in an error in a packet received or transmitted based on a network protocol. In some embodiments, the controller retrieves a list of active alarms and a list of closed alarms that occurred within a predetermined closed alarm threshold. In some embodiments, the controller determines the list of alarms based on the list of active alarms and a list of closed alarms.

In at least one example, the list of alarms are based on a list of active alarms and a list of closed alarms that were closed within a certain time threshold. In some embodiments, the alarm is closed in response to the error associated with an alarm at a faulty node being reported twenty-four hours prior and the network outage that caused the alarm is fixed. In some embodiments, the alarm is closed in response to the error associated with an alarm being based on a network outage that was fixed twenty-four hours prior.

In some embodiments, at S406 the controller determines a child node in the network located at the bottom of the topology that has a first alarm based on the alarm list. In at least one example, the controller determines the child node 108c in the network as shown in (FIG. 1), for example using the system 100.

In some embodiments, at S408 the controller determines a parent node of the child node located above the child node and below or on the same hierarchical level as the apex node of the network that has a second alarm based on the topology.

In some embodiments, the controller determines the highest node in the network hierarchy that has an alarm based on the list of alarms and the topology. In some embodiments, the controller based on a determination that the parent node is not the apex node in the network, determines whether a grandparent node above the parent node has an alarm based on the topology and the list of alarms. In some embodiments, the controller based on a determination that the grandparent node above the parent nodes does not have an alarm, identifies the parent node as the faulty node. In some embodiments, the controller based on a determination that the grandparent node above the parent nodes has an alarm, identifies the grandparent node as the faulty node.

In at least one example, the controller determines a parent node 108b of the child node 108c located above the child node 108c and below or on the same hierarchical level as an apex node 108a of the network that has a second alarm based on the topology, for example using system 100 (FIG. 1). In some embodiments, at S410 the controller determines whether the parent node is an apex node in the network based on the topology. In at least one example, the controller determines whether the parent node 108b is at the same hierarchical level as the apex node 108a in the network based on the topology, for example using system 100 (FIG. 1). In some embodiments, the controller at S412 based on a determination that the parent node is the apex node in the network, the controller identifies the parent node as the faulty node. In at least one example, the controller based on a determination that the parent node 108b is the apex node 108a in the network, identifies the parent node 108b as the faulty node, for example using system 100 (FIG. 1).

In some embodiments, the controller alerts an administrator about the faulty node. In some embodiments, the controller changes the configuration of the faulty node to fix the error associated with an alarm in configuration. In some embodiments, the controller recommends replacing the node to fix a faulty node. In some embodiments, the controller receives confirmation from the administrator that the faulty node has been replaced following replacement of the faulty node. In some embodiments, the controller, based on a determination that the parent node is not the apex node in the network, determines a grandparent node above the parent node that is closest to the apex node based on the topology has an alarm based on the topology and the list of alarms. In some embodiments, the controller determines whether the grandparent node has a sibling node with a sibling alarm located at the same hierarchical level as the grandparent node based on the topology and the list of alarms. In some embodiments, the controller based on a determination that the sibling node is located at the same hierarchical level as the grandparent node, determines whether the alarm on the grandparent node was triggered prior to the alarm on the sibling node. In some embodiments, the controller based on a determination that the alarm on the grandparent node was triggered prior to the alarm on the sibling node, identifies the grandparent node as the faulty node.

FIG. 5 is a block diagram of an exemplary hardware configuration for detecting the faulty node, according to at least one embodiment of the system. The exemplary hardware configuration includes the system 100, which communicates with network 509, and interacts with input device 507. In at least some embodiments, apparatus 500 is a computer or other computing device that receives input or commands from input device 507. In at least some embodiments, the system 100 is a host server that connects directly to input device 507, or indirectly through network 509. In at least some embodiments, the system 100 is a computer system that includes two or more computers. In at least some embodiments, the system 100 is a personal computer that executes an application for a user of the system 100.

The system 100 includes a controller 502, a storage unit 504, a communication interface 508, and an input/output interface 506. In at least some embodiments, controller 502 includes a processor or programmable circuitry executing instructions to cause the processor or programmable circuitry to perform operations according to the instructions. In at least some embodiments, controller 502 includes analog or digital programmable circuitry, or any combination thereof. In at least some embodiments, controller 502 includes physically separated storage or circuitry that interacts through communication. In at least some embodiments, storage unit 504 includes a non-volatile computer-readable medium capable of storing executable and non-executable data for access by controller 502 during execution of the instructions. Communication interface 508 transmits and receives data from network 509. Input/output interface 506 connects to various input and output units, such as input device 507, via a parallel port, a serial port, a keyboard port, a mouse port, a monitor port, and the like to accept commands and present information.

Controller 502 includes the Radio Unit (RU) 104, the Distributed Unit (DU) 106, the centralized Unit (CU) 110 and the core 114. In some embodiments, the Radio Unit (RU) 104, a Distributed Unit (DU) 106, a centralized Unit (CU) 110 and a core 114 are configured based on a virtual machine or a cluster of virtual machines. The DU 106, CU 110, core 114 or a combination thereof is the circuitry or instructions of controller 502 configured to process a stream of information from a DU 106, CU 110, core 114 or a combination thereof. In at least some embodiments, DU 106, CU 110, core 114 or a combination thereof is configured to receive information such as information from an open-RAN network. In at least some embodiments, the DU 106, CU 110, core 114 or a combination thereof is configured for deployment of a software service in a cloud native environment to process information in real-time. In at least some embodiments, the DU 106, CU 110, core 114 or a combination thereof records information to storage unit 504, such as the site database 890, and utilize information in storage unit 504. In at least some embodiments, the DU 106, CU 110, core 114 or a combination thereof includes sub-sections for performing additional functions, as described in the foregoing flow charts. In at least some embodiments, such sub-sections may be referred to by a name associated with their function.

In at least some embodiments, the apparatus is another device capable of processing logical functions in order to perform the operations herein. In at least some embodiments, the controller and the storage unit need not be entirely separate devices but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all the blocks of flowcharts and block diagrams described herein. Various embodiments of the present system are described with reference to flowcharts and block diagrams whose blocks may represent (1) steps of processes in which operations are performed or (2) sections of a controller responsible for performing operations. Certain steps and sections are implemented by dedicated circuitry, programmable circuitry supplied with computer-readable instructions stored on computer-readable media, and/or processors supplied with computer-readable instructions stored on computer-readable media. In some embodiments, dedicated circuitry includes digital and/or analog hardware circuits and may include integrated circuits (IC) and/or discrete circuits. In some embodiments, programmable circuitry includes reconfigurable hardware circuits comprising logical AND, OR XOR, NAND, NOR, and other logical operations, flip-flops, registers, memory elements, etc., such as field-programmable gate arrays (FPGA), programmable logic arrays (PLA), etc.

Various embodiments of the present system include a system, a method, and/or a computer program product. In some embodiments, the computer program product includes a computer readable storage medium (or media) having computer readable program instructions thereon for causing a processor to carry out aspects of the present system. In some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire. In some embodiments, computer readable program instructions described herein are downloadable to respective computing/processing devices from a computer readable storage medium or to an external computer or external storage device via a network, for example, the Internet, a local area network, a wide area network and/or a wireless network. In some embodiments, the network may include copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

In some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In some embodiments, the computer readable program instructions are executed entirely on the user's computer, partly on the user's computer, as a stand-alone software package, partly on the user's computer and partly on a remote computer or entirely on the remote computer or server. In some embodiments, in the latter scenario, the remote computer is connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present system.

While embodiments of the present system have been described, the technical scope of any subject matter claimed is not limited to the above-described embodiments. It will be apparent to persons skilled in the art that various alterations and improvements can be added to the above-described embodiments. It will also be apparent from the scope of the claims that the embodiments added with such alterations or improvements are included in the technical scope of the system.

The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the processes must be performed in this order.

While embodiments of the present system have been described, the technical scope of any subject matter claimed is not limited to the above-described embodiments. It will be apparent to persons skilled in the art that various alterations and improvements can be added to the above-described embodiments. It will also be apparent from the scope of the claims that the embodiments added with such alterations or improvements are included in the technical scope of the system. The operations, procedures, steps, and stages of each process performed by an apparatus, system, program, and method shown in the claims, embodiments, or diagrams can be performed in any order as long as the order is not indicated by “prior to,” “before,” or the like and as long as the output from a previous process is not used in a later process. Even if the process flow is described using phrases such as “first” or “next” in the claims, embodiments, or diagrams, it does not necessarily mean that the processes must be performed in this order.

According to at least one embodiment of the present system, a faulty node is identified in an application by retrieving an alarm list in the network, determining a child node in the network located at the bottom of the topology that has a first alarm based on the alarm list, determining a parent node of the child node located above the child node and below or on an apex node of the network that has a second alarm based on the topology, determining whether the parent node is an apex node in the network based on the topology, and based on a determination that the parent node is the apex node in the network, identifying the parent node as the faulty node. Some embodiments include the instructions in a computer program, the method performed by the processor executing the instructions of the computer program, and a system that performs the method. In some embodiments, the system includes a controller including circuitry configured to perform the operations in the instructions.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure. The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

1. A method comprising:
retrieving a topology that describes a relationship between a plurality of nodes in a wireless network;
retrieving an alarm list in the wireless network, wherein the alarm list is based on detected faults within the plurality of nodes;
determining a child node in the wireless network located at a bottom of the topology that has a first alarm is a first detected fault from the retrieved alarm list;
determining a parent node of the child node located above the child node and below or on an apex node of the wireless network that has a second alarm based on the topology, wherein the second alarm is a second detected fault from the retrieved alarm list;
determining whether the parent node is an apex node in the wireless network based on the topology; and
automatically identifying, in response to a determination that the parent node is the apex node in the network, the parent node as the faulty node using a processor connected to the wireless network.

2. The method of claim 1, comprising:
receiving a user configured topology correlation rule; and
determining the topology based on the user configured topology configuration rule.

3. The method of claim 1, comprising:
retrieving a list of active alarms and a list of closed alarms that occurred within a predetermined closed alarm threshold; and
determining the alarm list based on the list of active alarms and the list of closed alarms.

4. The method of claim 1, comprising:
based on a determination that the parent node is not the apex node in the wireless network, determining whether a grandparent node above the parent node has an alarm based on the topology and the list of alarms; and
based on a determination that the grandparent node above the parent nodes does not have an alarm, identifying the parent node as the faulty node.

5. The method of claim 1, comprising:
based on a determination that the parent node is not the apex node in the wireless network, determining a grandparent node above the parent node that is closest to the apex node based on the topology has an alarm based on the topology and the list of alarms; and
based on a determination that the grandparent node above the parent nodes has an alarm, identifying the grandparent node as the faulty node.

6. The method of claim 1, comprising:
based on a determination that the parent node is not the apex node in the wireless network, determining a grandparent node above the parent node that is closest to the apex node based on the topology has an alarm based on the topology and the list of alarms;
determining whether the grandparent node has a sibling node with a sibling alarm located at the same hierarchical level as the grandparent node based on the topology and the list of alarms;
based on a determination that the sibling node is located at the same hierarchical level as the grandparent node, determining whether the alarm on the grandparent node was triggered prior to the alarm on the sibling node; and
based on a determination that the alarm on the grandparent node was triggered prior to the alarm on the sibling node, identifying the grandparent node as the faulty node.

7. The method of claim 1, comprising:
generating an alert containing information about the faulty node; and
transmitting the alert to an administrator of the wireless network.

8. A system comprising:
a controller including circuitry configured to:
retrieve a topology that describes a relationship between a plurality of nodes in a wireless network;
retrieve a list of alarms in the wireless network, wherein the alarm list is based on detected faults within the plurality of nodes;
determine a child node in the wireless network located at a bottom of the topology that has a first alarm is a first detected fault from the retrieved alarm list;
determine a parent node of the child node located above the child node and below or on an apex node of the wireless network that has a second alarm based on the topology, wherein the second alarm is a second detected fault the retrieved alarm list;
determine whether the parent node is an apex node in the wireless network based on the topology; and
automatically identify, in response to a determination that the parent node is the apex node in the network, the parent node as the faulty node using a processor connected to the wireless network.

9. The system of claim 8, wherein the controller is configured to:
receive a user configured topology correlation rule; and
determine the topology based on the user configured topology configuration rule.

10. The system of claim 8, wherein the controller is configured to:
retrieve a list of active alarms and a list of closed alarms that occurred within a predetermined closed alarm threshold; and
determine the alarm list based on the list of active alarms and the list of closed alarms.

11. The system of claim 8, wherein the controller is configured to:
retrieve a list of active alarms and a list of closed alarms that occurred within a predetermined closed alarm threshold; and determine the alarm list based on the list of active alarms and [[a]] the list of closed alarms.

12. The system of claim 8, wherein the controller is configured to:
generate an alert containing information about the faulty node; and
transmit the alert to an administrator of the wireless network.

13. A non-transitory computer-readable medium including instructions executable by a computer to cause the computer to perform operations comprising:
retrieve a topology that describes a relationship between a plurality of nodes in a wireless network;
retrieve a list of alarms in the wireless network, wherein the alarm list is based on detected faults within the plurality of nodes;
determine a child node in the wireless network located at a bottom of the topology that has a first alarm is a first detected fault from the retrieved list of alarms;
determine a parent node of the child node located above the child node and below or on an apex node of the wireless network that has a second alarm based on the topology, wherein the second alarm is a second detected fault from the retrieved alarm list;
determine whether the parent node is an apex node in the wireless network based on the topology; and
automatically identify, in response to a determination that the parent node is the apex node in the network, the parent node as a faulty node using a processor connected to the wireless network.

14. The non-transitory computer-readable medium of claim 13, wherein the instructions executable by the computer are configured to cause the computer to:
receive a user configured topology correlation rule; and
determine the topology based on the user configured topology configuration rule.

15. The non-transitory computer-readable medium of claim 13, wherein the instructions executable by the computer are configured to cause the computer to:
retrieve a list of active alarms and a list of closed alarms that occurred within a predetermined closed alarm threshold; and
determine the list of alarms based on the list of active alarms and [[a]] the list of closed alarms.

16. The non-transitory computer-readable medium of claim 13, wherein the instructions executable by the computer are configured to cause the computer to:
based on a determination that the parent node is not the apex node in the network, determine whether a grandparent node above the parent node has an alarm based on the topology and the list of alarms; and
based on a determination that the grandparent node above the parent nodes does not have an alarm, identify the parent node as the faulty node.

17. The non-transitory computer-readable medium of claim 13, wherein the instructions executable by the computer are configured to cause the computer to:
based on a determination that the parent node is not the apex node in the network, determine a grandparent node above the parent node that is closest to the apex node based on the topology has an alarm based on the topology and the list of alarms; and
based on a determination that the grandparent node above the parent nodes has an alarm, identify the grandparent node as the faulty node.

18. The non-transitory computer-readable medium of claim 13, wherein the instructions executable by the computer are configured to cause the computer to:
based on a determination that the parent node is not the apex node in the network, determine a grandparent node above the parent node that is closest to the apex node based on the topology has an alarm based on the topology and the list of alarms;
determine whether the grandparent node has a sibling node with a sibling alarm located at the same hierarchical level as the grandparent node based on the topology and the list of alarms;
based on a determination that the sibling node is located at the same hierarchical level as the grandparent node, determine whether the alarm on the grandparent node was triggered prior to the alarm on the sibling node; and
based on a determination that the alarm on the grandparent node was triggered prior to the alarm on the sibling node, identify the grandparent node as the faulty node.

19. The non-transitory computer-readable medium of claim 13, wherein the instructions executable by the computer are configured to cause the computer to:
retrieve a list of active alarms in the wireless network;
retrieve a list of closed alarms in the wireless network that were closed within a closed alarm threshold; and
determine a list of alarms based on the list of active alarms and the list of closed alarms.

20. The non-transitory computer-readable medium of claim 13, wherein the instructions executable by the computer are configured to cause the computer to:
generate an alert containing information about the faulty node; and
transmit the alert to an administrator of the wireless network.
